(19) United States
(12) Patent Application Publication
(10) Pub. No.: US 2020/0076681 A1
(43) Pub. Date: Mar. 5, 2020

(54) VOLUME ALLOCATION MANAGEMENT APPARATUS, VOLUME ALLOCATION MANAGEMENT METHOD, AND VOLUME ALLOCATION MANAGEMENT PROGRAM

(71) Applicant: HITACHI, LTD., Tokyo (JP)

(72) Inventor: Souichi TAKASHIGE, Tokyo (JP)

(73) Assignee: HITACHI, LTD., Tokyo (JP)

(21) Appl. No.: 16/354,630

(22) Filed: Mar. 15, 2019

(30) Foreign Application Priority Data
Sep. 3, 2018 (JP) 2018-164187

(51) Int. Cl. H04L 12/24

(52) U.S. Cl. CPC H04L 41/0803; H04L 67/1097; H04L 41/147

(57) ABSTRACT

In an SDS-PaaS management server, a configuration information collector includes a configuration information collector, a configuration manager, an allocation manager, and a performance predictor. The configuration information collector collects system configuration information about a past processing system using a past volume and performance information about a past volume in the past processing system. The configuration manager acquires system configuration information about a new processing system using a new volume. The allocation manager determines a past processing system similar to a system configuration of a new processing system based on the system configuration information about the past processing system. The performance predictor predicts load information about a new volume based on performance information about a past volume used by a past processing system determined to be similar. The allocation manager is configured to determine an allocation plan of a new volume based on prediction contents of the load information.

### BACKGROUND

The present invention relates to a technology that manages allocation of volumes in a storage system including a plurality of general-purpose server nodes.

For example, it is known that a private cloud uses the SDS (Software Defined Storage) technology to provide a configuration to implement the storage function. The SDS technology uses a cluster of general-purpose servers, operates the storage control software for the cluster, and allows the cluster to function as a storage apparatus.

The SDS uses a cluster (SDS cluster) of general-purpose servers (nodes). Therefore, each node or several nodes in the cluster are subject to different degrees of I/O load concentration. The I/O load depends on the I/O load on a volume allocated to the SDS cluster. Namely, the I/O deviation (or the degree of averageness) of each node can vary depending on which volume is to be allocated to which node on the SDS cluster. The I/O inclines toward a specific node throughout the system as a whole. To avoid this as a bottleneck, the operation requires allocating volumes to the nodes in the cluster by dispersing loads. Unlike the existing VM (Virtual Machine) migration technology, moving volumes requires copying a large amount of data. A system that completes reallocation during a short period can load the entire system. In order to avoid frequent allocation transfer, it is important to predict I/O loads on volumes and plan the allocation and capacities of the volumes based on the prediction.

Nutanix discloses the technology called X-FIT as a technology concerning storage load prediction (see “Nutanix, NUTANIX MACHINE LEARNING ENGINE X-FIT, Internet (https://www.nutanix.com/go/nutanix-machine-learning-engine-x-fit.html)”). This technology is based on past time series, performs load predication as a continuation of the past time series using a plurality of systems, and selects a technique causing the least amount of errors as a load prediction technique for a targeted volume. Nutanix Calm, a Nutanix product, uses the technology that constructs middleware applications from the marketplace.

### SUMMARY

An existing load prediction technology collects resource load data along the time series from operations of a processing system using a loaded volume during a specified period in the past and predicts the future along the time series. When a new processing system is deployed, no prediction is available because there is no chronological data in the past for a targeted volume.

It is necessary to manually find and select a profile for the workload as a source of the load prediction if a new processing system is targeted. A human needs to determine whether a profile to be used is similar to the past system configuration and can be reused. Doing this requires the know-how corresponding to each processing system or each middleware used for the processing system. Therefore, it is difficult to determine to which node the volume should be allocated in a storage system comprised of a plurality of general-purpose server nodes.

The present invention has been made in consideration of the foregoing. It is an object of the invention to provide a technology capable of easily and appropriately allocating a volume to a node in a storage system comprised of a plurality of general-purpose server nodes.

To achieve the above-described object, a volume allocation management apparatus according to an aspect manages allocation of a volume in a storage system comprised of a plurality of general-purpose server nodes and includes a past system configuration information acquirer, a past volume performance information acquirer, a configuration information acquirer, a similar system determiner, a load predictor, and an allocation plan determiner. The past system configuration information acquirer acquires system configuration information in a past processing system using a past volume. The past volume performance information acquirer stores performance information about the past volume in the past processing system. The configuration information acquirer acquires system configuration information about a new processing system using a new volume. The similar system determiner determines a past processing system similar to a system configuration of the new processing system based on system configuration information about the past processing system. The load predictor predicts load information about the new volume based on performance information about a past volume used by a past processing system determined to be similar. The allocation plan determiner determines an allocation plan for the new volume based on prediction contents of the load information.

The present invention can easily and appropriately allocating a volume to a node in a storage system comprised of a plurality of general-purpose server nodes.

### BRIEF DESCRIPTION OF THE DRAWINGS

FIG. 1 is an overall configuration diagram illustrating a computer system according to an embodiment;

FIG. 2 is a configuration diagram illustrating a server, a node, and a computer of the computer system according to an embodiment;

FIG. 3 is a diagram illustrating a configuration of a processing system according to an embodiment;

FIG. 4 is a diagram illustrating another configuration of the processing system according to an embodiment;

FIG. 5 illustrates system configuration information according to an embodiment;

FIG. 6 is a configuration diagram illustrating PaaS configuration information history information according to an embodiment;

FIG. 7 is a diagram illustrating system configuration information according to an embodiment;

FIG. 8 is a diagram illustrating a configuration of PaaS configuration-performance history correspondence information according to an embodiment;

FIG. 9 is a flowchart illustrating an allocation optimization process according to an embodiment;

FIG. 10 is a flowchart illustrating a subsystem extraction process according to an embodiment; and

FIG. 11 is a flowchart illustrating a similarity determination process according to an embodiment.

### DETAILED DESCRIPTION

The description below explains the embodiment with reference to the accompanying drawings. The embodiment explained below does not limit the invention according to the scope of patent claims. All the elements and combinations thereof explained in the embodiment are not necessarily required for means to solve the problems of the invention.

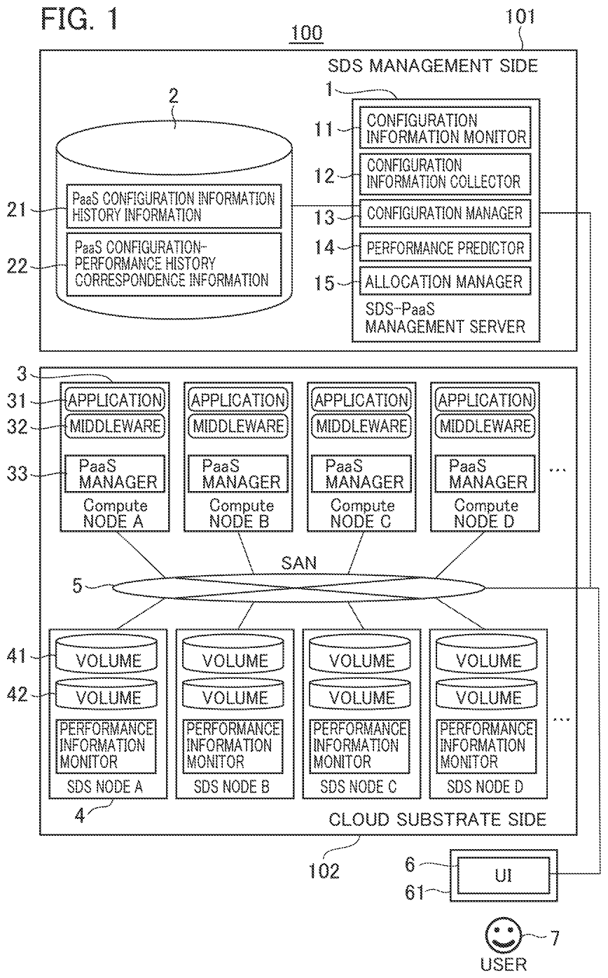

FIG. 1 is an overall configuration diagram illustrating a computer system according to an embodiment.

A computer system 100 includes an SDS-PaaS (Platform as a Service) management server 1, a storage apparatus 2, a plurality of Compute nodes 3, a plurality of SDS nodes 4, and a client computer 6. The SDS-PaaS management server 1 and the storage apparatus 2 are placed at an SDS management side 101. The Compute nodes 3, the SDS nodes 4, and the client computer 6 are placed at a cloud substrate side 102. The storage apparatus 2 is provided as HDD or SSD (Solid State Drive) and stores various types of information.

The SDS-PaaS management server 1, the Compute nodes 3, the SDS nodes 4, and the client computer 6 are connected via SAN (Storage Area Network) 5 as an example network.

The Compute node 3 operates workloads (an application 31 and middleware 32) of the processing system. The Compute node 3 includes a PaaS manager 33. The PaaS manager 33 is comparable to a container management tool. A CPU 201 (to be described) executes Kubernetes, open source software, to configure the PaaS manager 33, for example. The PaaS manager 33 manages the application 31 and the middleware 32 executed on the Compute node 3. The PaaS manager 33 provides control to deploy or monitor the middleware 32, for example. When deploying the middleware 32, the PaaS manager 33 transmits configuration information (middleware configuration information) and volume (storage volume) requirements for the middleware 32 to be deployed to the SDS-PaaS management server 1.

The SDS node 4 provides a general-purpose server node comprised of general-purpose servers. A plurality of SDS nodes 4 configure a storage cluster (an example of the storage system) and stores a volume 41. The SDS node 4 includes a performance information monitor 42. The performance monitor 42 monitors loads on the SDS node 4 or the volume 41 and issues a notification to the SDS-PaaS management server 1.

According to the present embodiment, a plan to allocate the volume 41 reduces to an issue that selects the SDS node 4 including the volume 41 used for the workload out of a storage cluster at the cloud substrate side 102.

The client computer 6 provides a user 7 with a PaaS management UI 61 that accesses the PaaS manager 33. Using the PaaS management UI 61, the user 7 can notify the PaaS manager 33 of a system configuration of a new processing system including the middleware and transmit a directive that deploys the new processing system. The PaaS management UI 61 is available as open source software such as Monocular when Kubernetes is used to configure the PaaS manager 33. Monocular can issue a directive that specifies blueprint information (Charts) containing the configuration of a processing system to be deployed and deploys the middleware 32 and a storage needed for the middleware 32 at a time. Upon receiving the directive, the PaaS manager 33 transmits the configuration information (middleware configuration information) about the middleware 32 to be deployed and volume requirements to the SDS-PaaS management server 1 when the middleware 32 is deployed.

The SDS-PaaS management server 1 is available as an example of the volume allocation management apparatus. The SDS-PaaS management server 1 steadily collects and manages load information about the SDS node 4 and the configuration information about the deployed system in cooperation with the PaaS manager 33 and the performance information monitor 42. The SDS-PaaS management server 1 includes a configuration information monitor 11, a configuration information collector 12, a configuration manager 13, a performance predictor 14, and an allocation manager 15. The configuration information monitor 11 is provided as an example of a past system configuration information acquirer. The configuration information collector 12 is provided as an example of a past volume performance information acquirer. The configuration manager 13 is provided as an example of a configuration information acquirer. The performance predictor 14 is provided as an example of a load predictor. The allocation manager 15 is provided as an example of a similar system determiner, an allocation plan determiner, a subsystem divider, a feature item extractor, a similarity determiner, and a selector. The configuration information monitor 11 collects (acquires) the middleware configuration information from the PaaS manager 33 and stores the middleware configuration information in PaaS configuration information history information 21 of the storage apparatus 2. The middleware configuration information will be described in detail later. The configuration information collector 12 periodically collects volume-based performance information (such as Read/Write IOPS (Input/Output per Second) and throughput) about SDS node 4 from the performance information monitor 42 and stores the performance information in PaaS configuration-performance history correspondence information 22 of the storage apparatus 2.

The configuration manager 13 receives a request to allocate a volume (new volume) from the PaaS manager 33 and performs a process concerning the volume allocation. The allocation request includes the middleware configuration information and volume requirements (such as size and availability) for the middleware 32. The performance predictor 14 performs a process that predicts the performance when the volume is allocated to the specified SDS node 4. The allocation manager 15 manages the volume allocation in the SDS node 4 of the SDS cluster.

The description below explains hardware configurations of the SDS-PaaS management server 1, the Compute node 3, the SDS node 4, and the client computer 6.

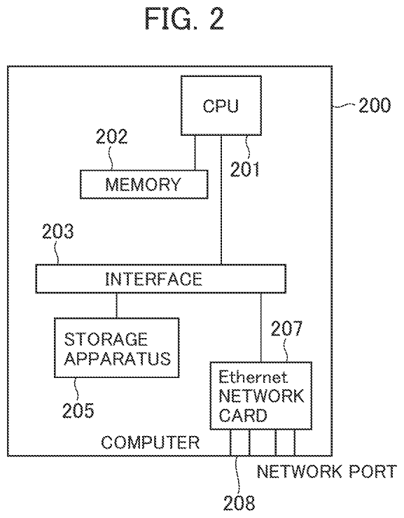

FIG. 2 is a configuration diagram illustrating a server, a node, and a computer of the computer system according to an embodiment.

A computer 200 illustrated in FIG. 2 configures the SDS-PaaS management server 1, the Compute node 3, the SDS node 4, and the client computer 6, for example.

The computer 200 includes a CPU (Central Processing Unit) 201 as an example processor, a memory 202, an interface 203, a storage apparatus 205, an Ethernet (registered trademark) network card 207, and a network port 208.

The Ethernet network card 207 enables communication with other apparatuses via a SAN 5. The network port 208 is used for connection to the SAN 5.

The CPU 201 performs various processes in accordance with a program stored in the memory 202 and/or the storage apparatus 205. The CPU 201 executes the program to configure function units illustrated in FIG. 1 in respective apparatuses. In the SDS-PaaS management server 1, for example, the CPU 201 executes a program stored in the storage apparatus 205 of the computer 200 to configure function units 11 through 15.

The memory 202 is provided as RAM (RANDOM ACCESS MEMORY), for example, and stores a program executed by the CPU 201 or necessary information.

The storage apparatus 205 includes at least one of HDD (Hard Disk Drive) and SSD (Solid State Disk), for example, and stores a program executed by the CPU 201 or data used by the CPU 201. Programs or data stored in the storage apparatus 203 depends on whether the computer 200 is used for the SDS-PaaS management server 1, the Compute node 3, the SDS node 4, or the client computer 6.

The interface 203 enables data exchange with the CPU 201, the storage apparatus 205, and the Ethernet network card 207.

When used as the client computer 6, the computer 200 favorably includes an input apparatus and an output apparatus. The input apparatus is provided as a mouse or a keyboard, for example, and accepts manipulation input from a user. The output apparatus is provided as a display, for example, and visually outputs various types of information.

The description below explains a processing system deployed by operating the specified middleware 32 in the computer system 100.

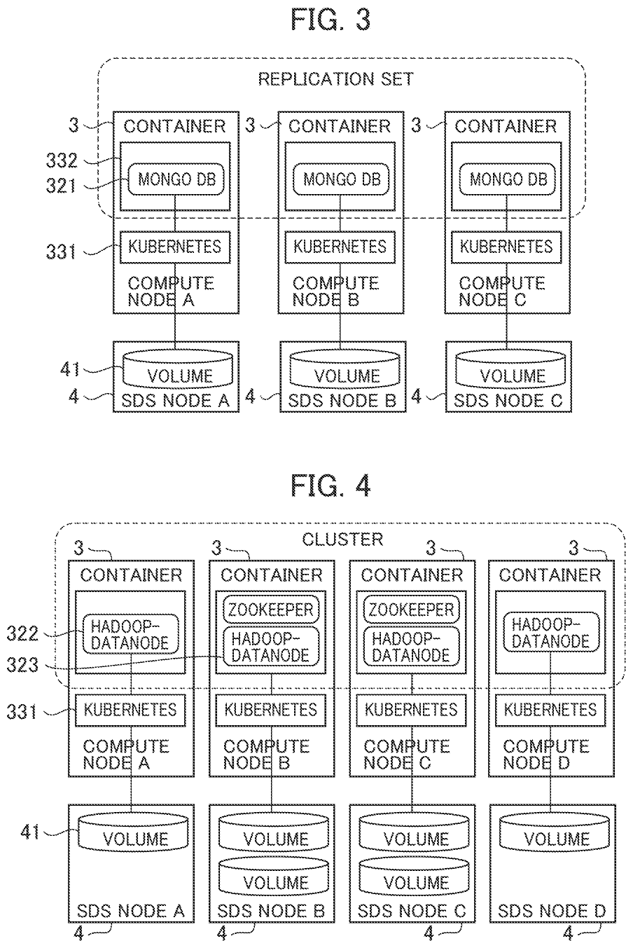

FIG. 3 is a diagram illustrating a configuration of a processing system according to an embodiment. FIG. 4 is a diagram illustrating another configuration of the processing system according to an embodiment. FIG. 3 illustrates an example of the processing system by deploying open source software MongoDB. FIG. 4 illustrates an example of the processing system by deploying open source software Hadoop. The examples in FIGS. 3 and 4 configure the PaaS manager 33 by executing Kubernetes 331.

As above, Kubernetes 331 uses the container orchestration technology to deploy and monitor the middleware 32 and an application 31. In FIG. 3, MongoDB 321 as the middleware 32 operates in a container 332. Each container 332 requires a data area to permanently use data. The data area is allocated to the volume 41 ensured in the SDS node 4. The data is stored in volume 41.

When MongoDB 321 is used, three Compute nodes 3 configure a cluster (replication set) to provide one processing system. In this cluster, one Compute node 3 normally behaves as an active node. The other Compute nodes 3 behave as backup nodes that redundantly maintain data.

As illustrated in FIG. 4, the processing system by deploying Hadoop operates each Hadoop function in the container managed by Kubernetes 331. When Hadoop is used, four Compute nodes 3 configure a cluster to provide one processing system, for example. Hadoop applies respective roles to the Compute nodes 3 in the cluster as different types of nodes such as namenode and datanode. Each of the Compute nodes 3 ensures the volume 41 as a dedicated data area.

The present embodiment performs a process that allocates the volume 41 based on the configurations in FIGS. 3 and 4 to any of the SDS nodes 4 in the SDS cluster. The volume 41 in FIGS. 3 and 4 is given different I/O characteristics. Moreover, each volume in FIGS. 3 and 4 is given different I/O characteristics depending on the role or the active or backup state in the cluster. It is necessary to allocate the volume in consideration of the characteristics based on the system configuration. Therefore, the allocation requires prediction of resource loads (such as IOPS) as the basis for the characteristics in order to avoid a bottleneck in the performance.

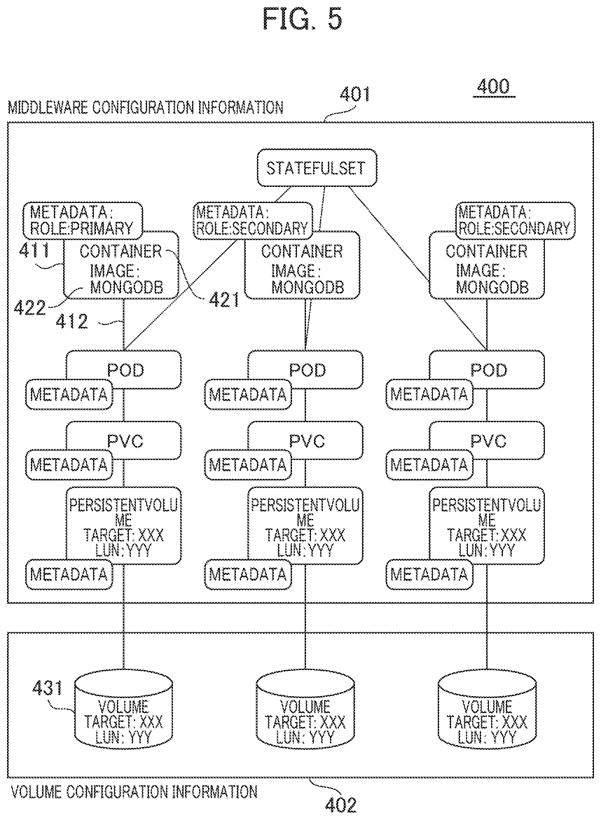

FIG. 5 illustrates system configuration information according to an embodiment.

FIG. 5 illustrates an example of system configuration information 400 the PaaS manager 33 uses for processing. The example configures PaaS manager 33 by executing Kubernetes 331. The system configuration information 400 includes middleware configuration information 401 and volume configuration information 402. The middleware configuration information 401 is collected from Kubernetes 331. The volume configuration information 402 is collected from the cluster (SDS cluster) in SDS node 4. Kubernetes 331 describes the middleware configuration information 401 as text information in the YAML format. The middleware configuration information 401 essentially represents a graph structure. Therefore, FIG. 5 represents the middleware configuration information 401 as graphed information. The middleware configuration information 401 illustrated in FIG. 5 provides an example of MongoDB used as the middleware 32.

The middleware configuration information 401 is represented by a node (resource node) 411 and a link 412. The resource node 411 represents a resource (system resource) configuring the system. The link 412 represents dependence relationship between resources. The system resource represents a constituent element in FIGS. 3 and 4 such as a container, a server, or a volume. The example in FIG. 5 represents the system resources as “Container” denoting a container, “Pod” denoting a server, “PVC” denoting a volume requirement, and “PersistentVolume” denoting a volume that satisfies the requirement and is connected to the container. These system resources are standard constituent elements of Kubernetes and a detailed description is omitted for simplicity.

Each resource node 411 is associated with a node type 421 and a node attribute 422. The node type 421 provides an identifier (resource type) representing the type of a resource node. According to the example in FIG. 5, “Pod” and “PersistentVolume” represent the resource type. The node attribute 422 represents a setup value for the resource node. The present embodiment represents the setup value using a combination of key values such as “item-name=setup-value.”

The volume configuration information 402 provides the configuration information about the volume 41 that can be acquired from the SDS node 4. The volume configuration information 402 includes information used for connection from the Compute node 3 and information (volume specification information) that can uniquely specify the volume 41 in the SSD cluster. The example in FIG. 5 uses an iSCSI target and an LUN (Logical Unit Number) for the volume specification information about a volume source 431. The volume specification information depends on the protocol of the SDS node 4, for example, and is not limited to the above-described example.

The present embodiment preconditions that PersistentVolume of the resource node included in Kubernetes and the corresponding volume source 431 are explicitly associated with each other. For example, the iSCSI target and the LUN are linked because they are included in both the PersistentVolume and the volume source that are associated with each other (assigned the same value in this example). The precondition is considered appropriate. If the precondition is missing, the volume source 431 specified by a manager cannot be reliably allocated to a specified middleware system configuration. This is impractical from the viewpoint of security or the confirmation of usage situations.

The configuration of a resource node more highly hierarchized than PersistentVolume is likely to use a different connection relationship depending on a designer of the configuration information or a system feature. For example, the resource nodes according to the system configuration illustrated in FIG. 5 are allocated under the single resource node StatefulSet. PersistentVolume is connected to Pod via the resource node PersistentVolumeClaim (PVC). However, another system configuration can define StatefulSet as a different node type such as Deployment. It is also possible to use a definition of directly connecting PersistentVolume to Pod.

It is difficult to determine the similarity of system configurations by using similar figures of graphs or a technique of comparing tree constructions. As will be described later, the present embodiment deals with this issue by extracting and comparing common subsystems based on the target (volume=PersistentVolume in the present embodiment) to be focused.

The PaaS configuration information history information 21 will be described.

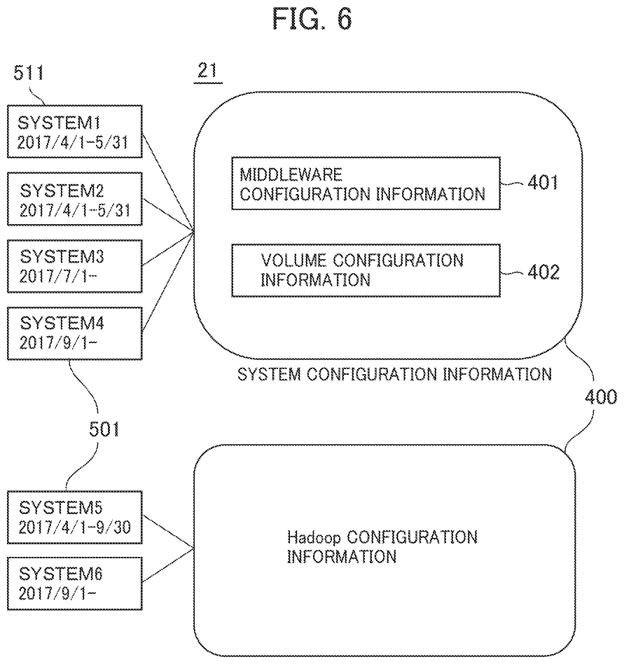

FIG. 6 is a configuration diagram illustrating PaaS configuration information history information according to an embodiment.

Suppose the user 7 uses the PaaS management UI 61 to specify the middleware configuration information 401 illustrated in FIG. 5 and specify deployment of the processing system. Then, the PaaS configuration information history information 21 accumulates the system configuration information 400 including the specified middleware configuration information 401 as the history. The processing system deployed in the past is comparable to a past processing system, storing the system configuration information 400 corresponding to the PaaS configuration information history information 21.

The PaaS configuration information history information 21 is associated with a system identifier 501 and the corresponding system configuration information 400. The system identifier 501 is capable of specifying a system deployed in the past. The system identifier 501 is associated with the system configuration information 400 based on N:1, where N is an integer greater than or equal to 1. The system identifier 501 is also associated with sub-attribute information 511 including the system creation date or the system creation date and removal date. This configuration enables the PaaS configuration information history information 21 to retrieve and specify the system identifier of the system using the volume source 431 at a specified date and time and the system configuration information 400 at that time. The PaaS configuration information history information 21 can also similarly manage the system configuration information 400 about a system deployed by other middleware (such as Hadoop).

The description below explains extraction (determination) of the subsystem characteristics information.

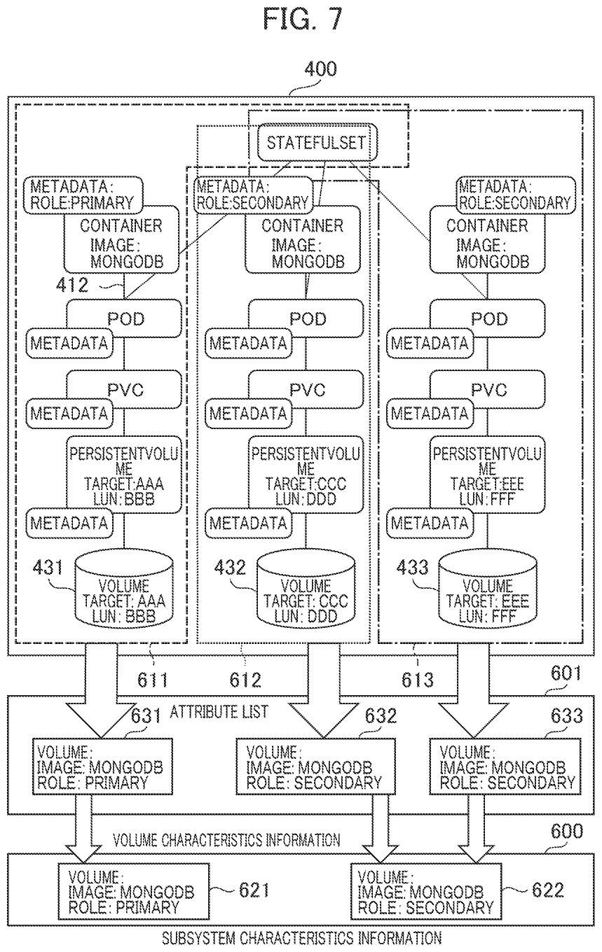

FIG. 7 is a diagram illustrating extraction of the system configuration information according to an embodiment.

The subsystem characteristics information 600 shows the feature of a subsystem in the processing system. The subsystem characteristics information 600 is used to determine the system configuration similarity between a newly deployed processing system (new processing system) and an already deployed processing system (past processing system) recorded in the PaaS configuration information history information 21. FIG. 7 illustrates the subsystem characteristics information 600 when the system configuration information 400 corresponds to the state illustrated in FIG. 5. A method of extracting the subsystem characteristics information 600 from the system configuration information 400 will be described in detail later. The subsystem characteristics information 600 is comparable to a feature quantity that concerns each volume included in the processing system and is considered to be a proper element of the volume in terms of the system configuration.

The process to extract the subsystem characteristics information 600 is generally comprised of three steps. The first step extracts paths that traverse the same type of resource nodes in the graph structure from the volume as a start point in the system configuration information 400. The path here signifies a sequential arrangement of resource nodes connected by the link 412 in the graph structure. Paths 611, 612, and 613 in FIG. 7 are extracted correspondingly to volume sources 431, 432, and 433 along the same node type including the volume, PersistentVolume, PVC, Pod, and StatefulSet in addition to corresponding Metadata, for example. The paths such as 611, 612, and 613 are hereinafter referred to as “common paths” corresponding to the volume sources.

The second step extracts a “feature attribute” from node attributes included in the common path. The feature attribute provides an attribute value associated with a specified resource node type. The feature attribute is assumed to be characteristics information about the volume. In FIG. 7, attribute lists 631, 632, and 633 are comparable to “feature attributes” extracted from the common paths 611, 612, and 613, respectively.

The third step performs a process that unifies attribute lists of duplicate contents from the attribute lists (such as the attribute lists 631, 632, and 633) extracted in the second step. The process finally provides the subsystem characteristics information 600. The example in FIG. 7 unifies the attribute lists 632 and 633 of duplicate contents from the attribute lists 631, 632, and 633 and provides a subsystem characteristics information element 621 corresponding to the attribute list 631 and a subsystem characteristics information element 622 unifying the attribute lists 632 and 633. Unifying the attribute lists of duplicate contents signifies treating the common paths as a basis for these attribute lists as one subsystem. In this case, the number of subsystems in the processing system is 2. As will be described later, the present embodiment determines the similarity of the processing system with the volume based on the number of subsystems and a rate of match with a character string for “feature attribute” in the subsystem characteristics information 600, for example.

The description below explains the PaaS configuration-performance history correspondence information 22.

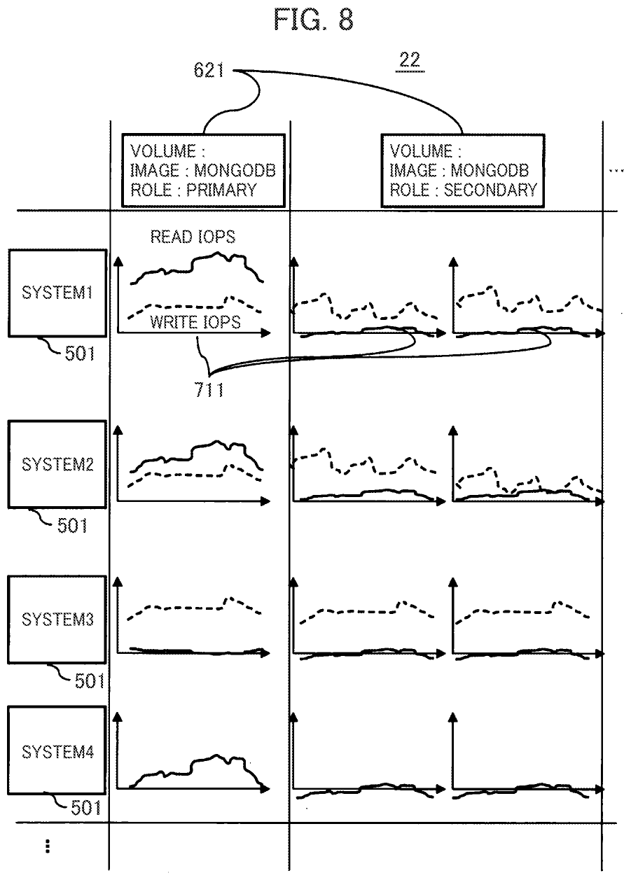

FIG. 8 is a diagram illustrating a configuration of PaaS configuration-performance history correspondence information according to an embodiment.

The example in FIG. 8 illustrates correspondence between the PaaS configuration according to the system configuration in FIG. 3 and the volume-based performance history. The PaaS configuration-performance history correspondence information 22 is configured as a table. The system identifiers 501 are placed vertically. The elements 621 of each subsystem characteristics information 600 are placed horizontally. Each crossing column chronologically stores performance information (volume performance information 711) about the volume corresponding to the subsystem characteristics information 600 for the system identifier 501 corresponding to the column. The performance information about the volume includes volume load information (such as IOPS and throughput). The volume load information is collected by the performance information monitor 42 of the SDS node 4 and by the configuration information collector 12 of the SDS-PaaS management server 1.

Generally, the performance information is configured so as to correspond to identification information (such as a set of iSCSI target IQN and LUN) that uniquely specifies the volume source 431, for example. As illustrated in FIG. 7, the system configuration information 400 of the PaaS configuration information history information 21 can be used to calculate (extract) the attribute list (631) corresponding to the volume source (such as 431) and the subsystem characteristics information 600. The system creation date (or the system creation date and removal date) and volume source identification information can be used to specify the system identifier 501 by keeping track of the association of the PaaS configuration information history information 21. Therefore, it is possible to calculate which column in the table needs to store the performance information about a given volume as illustrated in FIG. 8. When the subsystem characteristics information 600 about a given subsystem is found, the table makes it possible to select a column corresponding to the highest similarity to the subsystem characteristics information 600 and predict a storage resource load from a group of histories of the performance information along the corresponding row.

The description below explains an allocation optimization process that optimizes the volume allocation when the computer system 100 is provided with the SDS node 4 used for new processing system A. The allocation optimization process focuses on an issue of determining which SDS node 4 in the SDS cluster on the cloud substrate side 102 is used to generate volumes (1 through L) included in new processing system A. This issue can reduce to a mathematical issue of selecting the SDS nodes 4 (1 through M) corresponding to the volumes (1 through L), respectively.

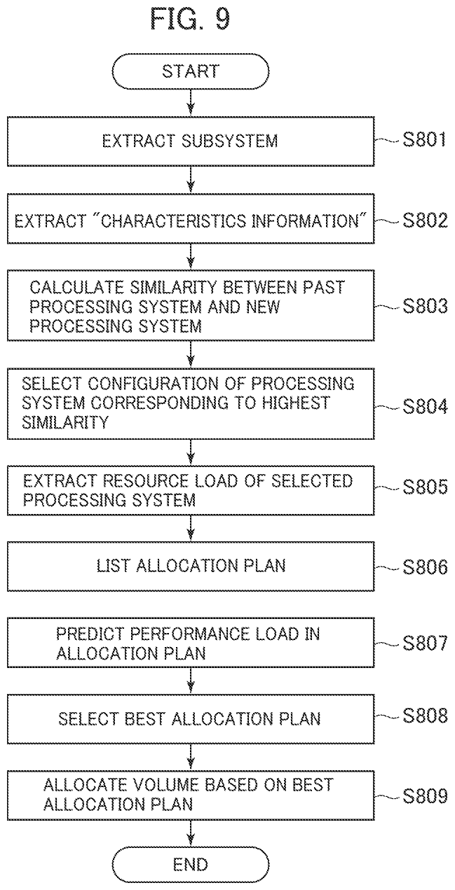

FIG. 9 is a flowchart illustrating an allocation optimization process according to an embodiment.

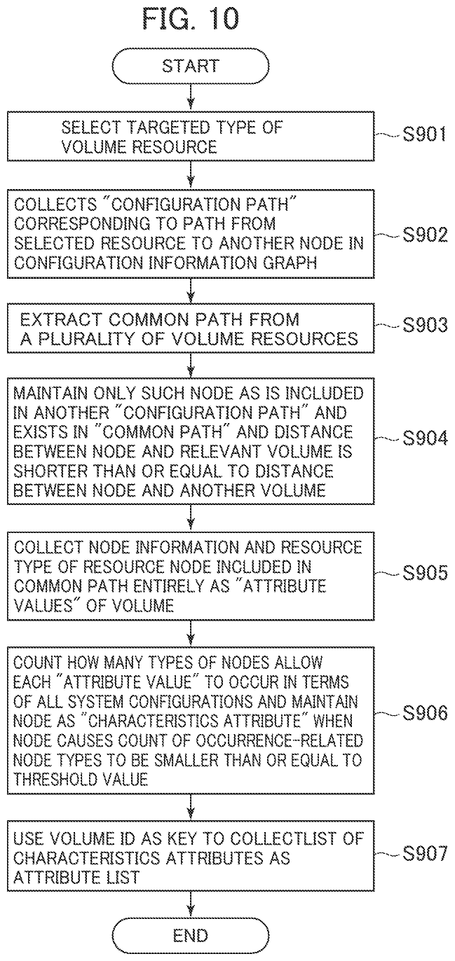

The allocation manager 15 of the SDS-PaaS management server 1 extracts subsystems with reference to the volume as a start point from the new processing system (processing system A in the description of this process) and all processing systems (past processing system: processing system B) accumulated in the system configuration information history information 21 (step S801). Specifically, the SDS-PaaS management server 1 extracts common paths (subsystems) such as the common paths 611, 612, and 613 in FIG. 7 from all the processing systems including the new processing system and the past processing systems. Step S801 will be described in detail with reference to steps S901 through S905 in FIG. 10.

The allocation manager 15 extracts “characteristics information” about a subsystem extracted in step S801 (step S802). Specifically, the allocation manager 15 extracts volume characteristics information (such as volume characteristics information 631, 632, and 633 in FIG. 7) from the common paths (such as common paths 611, 612, and 613 in FIG. 7) of the subsystem. Step S802 will be described in detail with reference to steps S906 and S907 in FIG. 10.

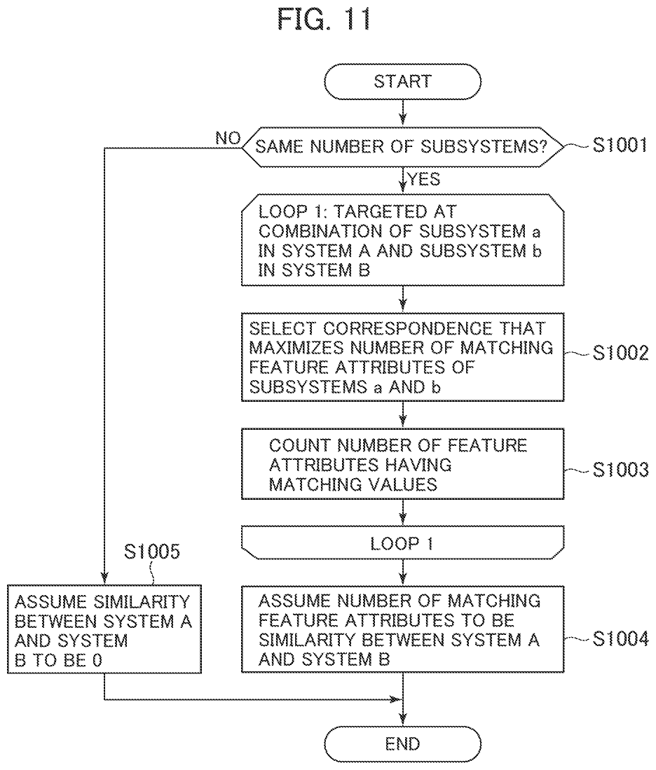

With reference to “characteristics information” extracted in step S802, the allocation manager 15 calculates the similarity of the processing system based on the number of subsystems and the number of character string matches for “feature attribute” in terms of processing system B and processing system A saved in the PaaS configuration information history information 21 (step S803). Step S803 will be described in detail with reference to steps S1001 through S1005 in FIG. 11.

In terms of steps S801 through S803, the allocation manager 15 calculates the similarity among all processing systems B and processing systems A included in the PaaS configuration information history information 211, sorts processing systems B in ascending order of similarities, and selects the configuration of processing system B corresponding to the highest similarity (step S804).

The allocation manager 15 references the PaaS configuration-performance history correspondence information 22 and extracts a resource load on processing system B selected instep S804 (step S805). Specifically, the allocation manager 15 searches the table-form PaaS configuration-performance history correspondence information 22 in FIG. 7 for the subsystem characteristics information in the column direction, finds a column for the subsystem characteristics information corresponding to the volume to be allocated anew and extracts all performance histories along the row direction corresponding to the column. Based on the extracted performance histories, the allocation manager 15 calculates a resource load (such as IOPS) concerning the volume. There are calculation methods to find a resource load by selecting a maximum load (IOPS) per read/write time, calculating an average value of IOPS, and finding a median of IOPS, for example. The capacity of a container or a volume may differ from the past configuration. In such a case, the IOPS maybe adjusted to the current state by calculating the IOPS in proportion to the capacity.

The allocation manager 15 lists allocation plans (step S806). The volume allocation here reduces to an issue of selecting the SDS nodes 4 (1 through M) corresponding to the volumes (1 through L), respectively. The allocation manager 15 visually outputs an allocation plan that permutationally combines the SDS node 4 to be used with the volume based on the configuration of the past processing system extracted in step S804.

The allocation manager 15 allows the performance predictor 14 to predict a performance load on the SDS cluster in each allocation plan (step S807). Specifically, the allocation manager 15 allocates the volume by using the allocation plan in step S806 and calculates an extent of the actual performance (such as input performance and output performance) of the SDS cluster when the resource load predicted in step S805 is applied. An existing simulator maybe used to predict the behavior of the SDS cluster. The simulator may be available as queue-based CloudSim, for example.

The allocation manager 15 selects the best allocation plan that exhibits the optimal total performance value during the performance load prediction in step S807 (step S808). The allocation manager 15 allocates the volume to the SDS node 4 based on the selected best allocation plan (step S809).

According to the above-described allocation optimization process, the PaaS manager 33 specifies the middleware configuration information 401 about a new processing system and is thereby capable of appropriately determining and allocating the SDS node 4 optimal to allocate a volume that satisfies the volume requirement (PersistentVolume according to the example in FIG. 5) described in the middleware configuration information 401.

The description below explains a subsystem extraction process corresponding to steps S801 and S802 in FIG. 9.

FIG. 10 is a flowchart illustrating a subsystem extraction process according to an embodiment.

The allocation manager 15 selects a volume source whose type is targeted in the middleware configuration information 401 and the volume configuration information 402 (step S901) . The example in FIG. 7 selects the volume sources 431, 432, and 433 as the targets.

Based on the middleware configuration information 401, the allocation manager 15 collects a “configuration path” that reaches a resource node by traversing linked resource nodes for a specified number of times from the volume source selected in step S901 (step S902). According to the example in FIG. 7, all resource nodes are linked and therefore all links are extracted for all volumes.

The allocation manager 15 extracts a “common path,” namely, a configuration path that traverses resource nodes of the “same type” from a plurality of volume sources as start points (step S903). The example in FIG. 7 extracts the common path, namely, the configuration path that traverses the same node type such as “PersistentVolume-PVC-Pod-Container-Metadata” from the volume sources 431, 432, and 433 as start points.

Suppose the “common path” includes a resource node that is included in the “configuration path” for another volume source. Then, the allocation manager 15 ensures only a resource node that causes the distance from the volume source as a start point in the path to be shorter than or equal to the distance from another volume source in the graph (step S904). For example, the configuration path from the volume source 431 as a start point includes the path “PersistentVolume-PVC-Pod-StatefulSet-Pod-PVC.” However, StatefulSet including the succeeding part is nearer to the volume source 432 or 433. The allocation manager 15 discards StatefulSet including the succeeding part from the common path.

The allocation manager 15 collects the node attribute and the node type of a resource node included in the common path entirely as “attribute values” of the volume (step S905). The node attribute is comparable to “image:mongoDB” included in the resource node of Container or “Role:primary” included in the resource node of Metadata, for example. The notion of being included in the common path is not limited thereto. For example, an attribute list of the volume may be provided by collecting all node attribute values for all the resource nodes. The above-described steps S901 through S905 correspond to step S801.

In terms of the configurations of all the processing systems, each attribute value is counted to determine how many types of resource nodes allow the attribute value to occur and to determine how many types of system identifiers are associated with the constituent elements that allow the attribute value to occur. If the counted result (occurrence frequency) is smaller than a specified threshold value, the attribute value is maintained as a “characteristics attribute” (step S906). For example, a counted result maybe replaced by multiplying the number of node types allowing the attribute value to occur and the number of systems together. It is then determined whether the calculation result is smaller than or equal to the threshold value. If the calculation result is smaller than the threshold value, the attribute value may be maintained as the characteristics attribute. This makes it possible to assume an attribute value considered as the feature in the common path to be the characteristics information.

For example, an attribute value in the form of “CreationTimeStamp:XX-YY-ZZ” occurs in all resource nodes and therefore occurs in all node types. However, an attribute value in the form of “image:yyy” occurs only in a specific node type of resource node such as Container. An attribute value such as “Primary” or “Secondary” occurs only in the system based on a specific cluster configuration. Therefore, node types are limited and the number of systems allowing the attribute value to occur is limited. The technique is assumed to multiply the number of node types allowing the attribute value to occur and the number of systems together and to compare a calculation result with the threshold value. Then, a universally occurring attribute value such as “CreationTimeStamp:XX-YY-ZZ” is counted many times and therefore often exceeds the threshold value. The attribute value can be removed from candidates for the characteristics attribute to be maintained. Meanwhile, an attribute value such as “image:yyy,” “Primary,” or “Secondary” causes a small number of counts to be often smaller than the threshold value and therefore can be maintained as the characteristics attribute.

The allocation manager 15 uses the volume ID as a key to collect a list of characteristics attributes as an attribute list and forms a result of unifying the same type of attribute lists into the subsystem characteristics information 600 (step S907). This step generates volume characteristics information 601 and the subsystem characteristics information 600 in FIG. 7. When attribute lists of the same type are unified, similar common paths are treated as the volume characteristics information about one common path. This makes it possible to manage the subsystem characteristics information 600 including a volume characteristics information element corresponding to each type of common path. According to the example in FIG. 7, the number of subsystems (types) in the system is 2. This makes it possible to compare the past processing system with the new processing system in terms of the type of subsystems in the system configuration. The above-described steps S906 and 907 correspond to step S802.

The description below explains a similarity determination process corresponds to step S803 in FIG. 9.

FIG. 11 is a flowchart illustrating a similarity determination process according to an embodiment.

Processing system A denotes a new processing system. Processing system B denotes a past processing system already stored in the past. The allocation manager 15 determines whether the number of subsystems (or the number of types according to the present embodiment) in processing system A equals that in processing system A based on the subsystem characteristics information 600 acquired from the subsystem extraction process illustrated in FIG. 10 (step S1001). If the result shows that the numbers of subsystems differ from each other (step S1001: N), the allocation manager 15 assumes the similarity between processing system A and processing system B to be 0 denoting the least similarity (step S1005) and terminates the process.

If the numbers of subsystems equal to each other (step S1001: Y), the allocation manager 15 performs the process (steps S1002 and S1003) corresponding to loop 1 on each of combinations of subsystems in processing system A and those in processing system B. In the combination of process targets, suppose subsystem a denotes a subsystem in processing system A and subsystem b denotes a subsystem in processing system B.

During the process of loop 1, the allocation manager 15 compares subsystem a with subsystem b in terms of the feature attribute as a character string on an item basis (row basis). The allocation manager 15 then selects the correspondence between items of the feature attribute so as to provide the maximum number of matching rows (step S1002).

The allocation manager 15 counts the number of feature attributes whose values match in the selected correspondence (step S1003).

Suppose the process of loop 1 (steps S1002 and S1003) is performed on all the combinations. Then, the allocation manager 15 terminates the process of loop 1 and totals the number of matching feature attributes counted in step S1003 in terms of each combination. The allocation manager 15 assumes the total to be the similarity between processing system A and processing system B (step S1004) and terminates the process.

A subsystem comparison process can appropriately determine the similarity between a new processing system and each past processing system already stored in the past.

The present invention is not limited to the above-mentioned embodiment and may be embodied in various modifications without departing from the spirit and scope of the invention.

According to the above-described embodiment, for example, the storage apparatus 2 different from the SDS-PaaS management server 1 stores the PaaS configuration information history information 21 and the PaaS configuration-performance history correspondence information 22. The present invention is not limited thereto. The storage apparatus 205 of the SDS-PaaS management server 1 may store at least one of the PaaS configuration information history information 21 and the PaaS configuration-performance history correspondence information 22.

A dedicated hardware circuit may replace all or some of the processes performed by the CPU according to the above-described embodiment. The program according to the above-described embodiment may be installed from a program source. The program source may be provided as a program distribution server or a storage medium (such as a portable storage medium).

1. A volume allocation management apparatus that manages allocation of a volume in a storage system configured by a plurality of general-purpose server nodes, comprising:
a past system configuration information acquirer that acquires system configuration information in a past processing system using a past volume;
a past volume performance information acquirer that stores performance information about the past volume in the past processing system;
a configuration information acquirer that acquires system configuration information about a new processing system using a new volume;
a similar system determiner that determines a past processing system similar to a system configuration of the new processing system based on system configuration information about the past processing system;
a load predictor that predicts load information about the new volume based on performance information about a past volume used by a past processing system determined to be similar; and
an allocation plan determiner that determines an allocation plan for the new volume based on prediction contents of the load information.

2. The volume allocation management apparatus according to claim 1, wherein the similar system determiner includes:
a subsystem divider that divides each of the past processing system and the new processing system into at least one subsystem based on a volume using a system configuration;
a feature item extractor that acquires attribute information about the divided subsystem and extracts a feature item in the subsystem based on an occurrence frequency of the attribute information;
a similarity determiner that determines similarity based on a degree of match between a feature item of a subsystem in the new processing system and a feature item of a subsystem in the past processing system; and
a selector that selects a past processing system similar to a system configuration of the new processing system based on the similarity.

3. The volume allocation management apparatus according to claim 2, wherein the subsystem divider uses a subsystem defined as each of sets of common parts capable of traversing the same type of resource along a resource path from each volume as a start point in the system configuration of the past processing system and the new processing system.

4. The volume allocation management apparatus according to claim 3, wherein, when a resource is capable of being traversed from a plurality of volumes in the subsystem is nearer to another volume than to one volume as a start point, the subsystem divider removes the resource from a subsystem including the one volume as a start point.

5. The volume allocation management apparatus according to claim 1, wherein the load predictor extracts at least one actual value from load information about a past volume used by the past processing system determined to be similar and predicts load information about the new volume based on statistics information about an extracted actual value.

6. The volume allocation management apparatus according to claim 1, wherein the system configuration information about one of the past processing system and the new processing system includes configuration information about middleware configuring one of the past processing system and the new processing system and volume configuration information in a storage system used by one of the past processing system and the new processing system.

7. The volume allocation management apparatus according to claim 2, wherein, when a match is found in feature items for a plurality of subsystems in each of the past processing system and the new processing system, the similarity determiner assumes a plurality of subsystems having a matching feature item to be one subsystem and determines the similarity based on the number of subsystems in the past processing system and the new processing system.

8. The volume allocation management apparatus according to claim 7, wherein the similarity determiner determines similarity to be a lowest value when the number of subsystems differs in the past processing system and the new processing system.

9. A volume allocation management method using a volume allocation management apparatus that manages allocation of a volume in a storage system configured by a plurality of general-purpose server nodes, comprising:
acquiring system configuration information in a past processing system using a past volume and acquiring performance information about the past volume in the past processing system;
acquiring system configuration information about a new processing system using a new volume;
determines a past processing system similar to a system configuration of the new processing system based on system configuration information about the past processing system; and
predicting load information about the new volume based on performance information about a past volume used by a past processing system determined to be similar and determining an allocation plan for the new volume based on prediction contents of the load information.

10. A volume allocation management program performed by a computer configuring a volume allocation management apparatus that manages allocation of a volume in a storage system configured by a plurality of general-purpose server nodes, the volume allocation management program allowing the computer to function as:
a configuration information acquirer that acquires system configuration information about a new processing system using a new volume;
a similar system determiner that determines a past processing system similar to a system configuration of the new processing system based on system configuration information about the past processing system;
a load predictor that predicts load information about the new volume based on performance information about a past volume used by a past processing system determined to be similar; and
an allocation plan determiner that determines an allocation plan for the new volume based on prediction contents of the load information.
